(19) United States
(12) Patent Application Publication
(10) Pub. No.: US 2008/0266372 A1
(43) Pub. Date: Oct. 30, 2008

(54) INK-JET PRINTER

(75) Inventor: Yoshikazu KOIKE, Chino-shi (JP)

Correspondence Address: MR. REINALDO P. ARROYO, BOX 1513, MAYAGUES PURETO RICO, PR, 00709, US

(73) Assignee: Seiko Epson Corporation, Tokyo (JP)

(21) Appl. No.: 11/969,006

(22) Filed: Jan. 3, 2008

(30) Foreign Application Priority Data
Jan. 5, 2007 (JP) 2007-000439

(51) Int. Cl. B41J 2/01

(52) U.S. Cl. 347/104

(57) ABSTRACT

An ink-jet printer includes a transporting unit that includes a plurality of transporting belts for transporting a print medium disposed at predetermined intervals in the width direction of the print medium; a first ink-jet head that discharges ink droplets to the print medium disposed on the transporting belts, the centerline of the printing area of the first ink-jet head in the width direction of the print medium corresponding to that of the transporting force of the transporting belts in the width direction of the print medium; a second ink-jet head disposed in series of the first ink-jet head in a direction in which the print medium is transported, the centerline of the printing area of the second ink-jet head in the width direction of the print medium corresponding to that of the printing area of the first ink-jet head in the width direction of the print medium; and a print-medium guide that adjusts the position of the centerline of the print medium in the width direction thereof such that the centerline of the print medium corresponds to that of the transporting force of the transporting belts in the width direction of the print medium when the print medium is placed on the transporting belts.

### BACKGROUND

1. Technical Field

The present invention relates to ink-jet printers capable of forming predetermined letters and images on print media by, for example, discharging minuscule ink droplets of a plurality of colors from a plurality of nozzles so as to form minute particles (ink dots) on the print media.

2. Related Art

Such ink-jet printers have been in widespread use by general users in addition to users in offices along with the popularization of personal computers, digital cameras, and the like since such ink-jet printers can easily produce high-quality color prints at low cost. A typical ink-jet printer of this type includes a movable body, often referred to as a carriage, to which an ink cartridge and a printing head are attached in an integrated manner, and produces desired prints on which predetermined letters and images are formed by discharging (ejecting) ink droplets from nozzles of the printing head while the movable body is reciprocated on print media in the width direction of the print media so as to form minute ink dots on the print media. When the carriage includes a plurality of ink cartridges and printing heads for four colors of black, yellow, magenta, and cyan; the ink-jet printer can easily print in full color by combining the colors in addition to black-and-white printing. These days, ink-jet printers using six, seven, or eight colors including, for example, light cyan and light magenta are now in practical use.

Ink-jet printers of this type, printing while reciprocating the ink-jet heads on the carriages in the width direction of the print media, need to reciprocate the ink-jet heads approximately ten to a few tens or more times such that a whole page can be finely printed. In contrast, ink-jet printers including long ink-jet heads (not necessarily single units) having lengths corresponding to the widths of print media and not including carriages do not need to reciprocate the ink-jet heads in the width direction of the print media, and can print at high speed in a so-called one pass. In general, the ink-jet printers of the former type are referred to as “ink-jet printers of the multi-pass (serial) type”, and those of the latter type are referred to as “ink-jet printers of the line-head type”. In the ink-jet printers of the line-head type, in particular, print media are transported while being adhered to transporting belts using electrostatic attraction, attraction by air suction, and the like.

Such methods for transporting print media are especially effective for the ink-jet printers of the line-head type capable of high-speed printing. An ink-jet printer described in JP-A-2005-75475 includes ink-jet heads of the line-head type disposed at two different positions in a direction along which print media are transported (print-medium transporting direction) and a plurality of transporting belts disposed at predetermined intervals in the width direction of the print media. The print media are electrostatically adhered to the transporting belts while being transported, and ink droplets are discharged from each of the ink-jet heads disposed at two different positions in the print-medium transporting direction onto the print media for printing. Nozzles of the ink-jet heads are, for example, recovered, i.e., cleaned by cleaning units disposed immediately below the ink-jet heads and between the transporting belts. An ink-jet printer described in JP-A-2005-88329 includes side guides disposed at a paper-feeding section for setting the positions of the sides of print media in the width direction thereof in order to accurately transport the print media to the printing areas of ink-jet heads. The centerline of the print media in the width direction thereof corresponds to that of the printing area in the width direction of the print media.

However, in the ink-jet printers described in JP-A-2005-88329, the centerlines of the transporting forces of upstream and downstream transporting-belt groups acting on print media having a size corresponding to the maximum width of the printing area do not correspond to each other. This leads to the rotation of the print media.

### SUMMARY

An advantage of some aspects of the invention is that an ink-jet printer is provided such that a print medium can be placed on a print-medium transporting unit including a plurality of transporting belts at an appropriate position and at an appropriate angle even when ink-jet heads are disposed at different positions in a direction in which the print medium is transported.

An ink-jet printer according to an aspect of the invention includes a transporting unit that includes a plurality of transporting belts for transporting a print medium disposed at predetermined intervals in the width direction of the print medium; a first ink-jet head that discharges ink droplets to the print medium disposed on the transporting belts, the centerline of the printing area of the first ink-jet head in the width direction of the print medium corresponding to that of the transporting force of the transporting belts in the width direction of the print medium; a second ink-jet head disposed in series of the first ink-jet head in a direction in which the print medium is transported, the centerline of the printing area of the second ink-jet head in the width direction of the print medium corresponding to that of the printing area of the first ink-jet head in the width direction of the print medium; and a print-medium guide that adjusts the position of the centerline of the print medium in the width direction thereof such that the centerline of the print medium corresponds to that of the transporting force of the transporting belts in the width direction of the print medium when the print medium is placed on the transporting belts.

According to the ink-jet printer, the centerline of the transporting force of the transporting unit including the plurality of transporting belts and that of the transporting load generated at the print-medium guide and a paper-feeding section correspond to each other in the width direction of the print medium, and the print medium can be placed on the transporting unit at an appropriate position and at an appropriate angle.

The print-medium guide can be separated from the print medium before ink droplets are discharged from the ink-jet heads. With this, changes in position of the print medium caused by the transporting load generated at the print-medium guide while ink droplets are discharged from the ink-jet heads (during printing) can be reliably prevented.

The ink-jet printer can further include one or more transporting units, including a plurality of transporting belts, disposed at different positions in the direction in which the print medium is transported, and the centerlines of the transporting forces of the transporting units can correspond to each other in the width direction of the print medium. With this, the centerlines of the transporting forces of the transporting units reliably correspond to those of the transporting loads generated at the print-medium guide and the paper-feeding section in the width direction of the print medium when the print medium is placed on the transporting belts of any one of the transporting units, and the print medium can be placed on the transporting units at an appropriate position and at an appropriate angle.

The transporting belts can have the same width, and the centerline of the transporting force of the transporting belts can correspond to that of the transporting belts in the width direction of the print medium. With this, the centerline of the transporting force of the transporting belts in the width direction of the print medium can be easily found. This facilitates the implementation of the invention.

### BRIEF DESCRIPTION OF THE DRAWINGS

The invention will be described with reference to the accompanying drawings, wherein like numbers reference like elements.

FIGS. 1A and 1B are a top view and a side view, respectively, of an ink-jet printer according to a first embodiment of the invention.

FIG. 2 is a block diagram of the ink-jet printer shown in FIGS. 1A and 1B.

FIGS. 3A and 3B illustrate the effect of the ink-jet printer shown in FIGS. 1A and 1B.

FIGS. 4A and 4B illustrate the effect of the ink-jet printer shown in FIGS. 1A and 1B.

FIGS. 5A and 5B illustrate the effect of a comparative example of the ink-jet printer shown in FIGS. 1A and 1B.

### DESCRIPTION OF EXEMPLARY EMBODIMENT

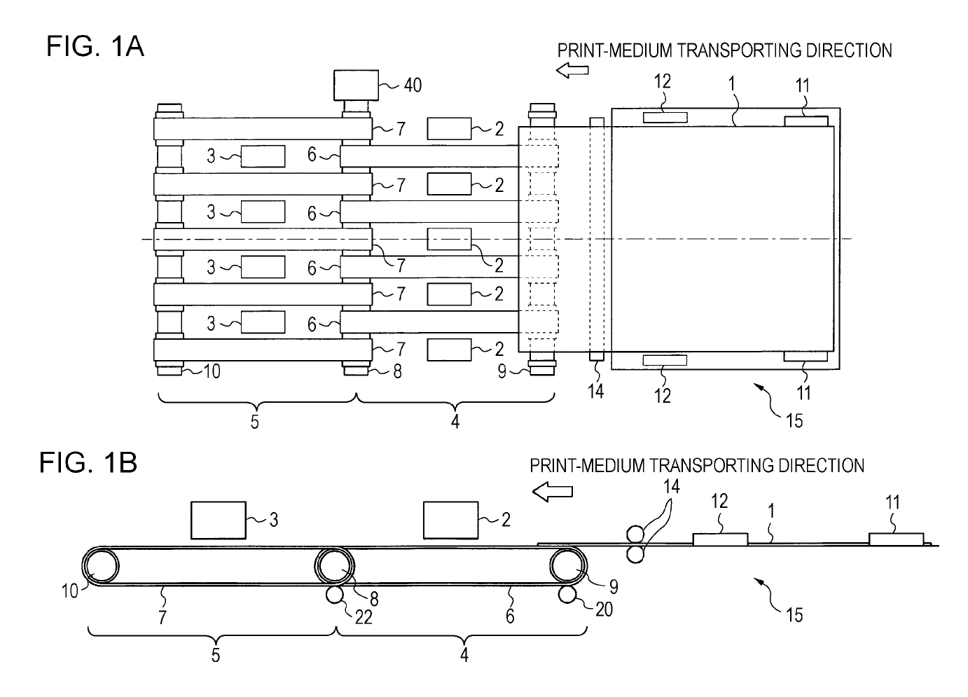

An ink-jet printer according to an embodiment of the invention will now be described with reference to the drawings. FIGS. 1A and 1B are a top view and a side view, respectively, of the ink-jet printer of the line-head type according to this embodiment. In FIGS. 1A and 1B, a print medium 1 is transported from right to left in the direction of arrows, and letters and images are printed on the print medium 1 in printing areas on the transporting path of the print medium 1. The ink-jet printer according to this embodiment includes ink-jet heads disposed at two different positions in a direction along which the print medium 1 is transported (print-medium transporting direction).

The ink-jet printer includes first ink-jet heads 2 disposed upstream in the print-medium transporting direction, second ink-jet heads 3 disposed downstream in the print-medium transporting direction, a first transporting unit 4 disposed below the first ink-jet heads 2 so as to transport the print medium 1, and a second transporting unit 5 disposed below the second ink-jet heads 3. The first transporting unit 4 includes four first transporting belts 6 disposed at predetermined intervals in the width direction of the print medium 1 (hereinafter also referred to as a nozzle-array direction). Similarly, the second transporting unit 5 includes five second transporting belts 7 disposed at predetermined intervals in the width direction of the print medium 1 (nozzle-array direction). The transporting belts 6 and 7 have the same width.

The four first transporting belts 6 and the five second transporting belts 7 are alternately disposed in a staggered manner. A driving roller 8 is disposed at a position where the transporting belts 6 and 7 overlap each other. A first driven roller 9 is disposed upstream of the driving roller 8, and a second driven roller 10 is disposed downstream of the driving roller 8. The first transporting belts 6 are wound around the driving roller 8 and the first driven roller 9, and the second transporting belts 7 are wound around the driving roller 8 and the second driven roller 10. A transporting-belt driving motor 40 is connected to the driving roller 8 for driving the transporting belts. When the driving roller 8 is rotated by the transporting-belt driving motor 40, the first transporting unit 4 constituted by the first transporting belts 6 and the second transporting unit 5 constituted by the second transporting belts 7 are synchronously driven at the same speed, and transport the print medium 1 placed on the transporting units 4 and 5 in the print-medium transporting direction shown by the arrows. In this embodiment, the print medium 1 is electrostatically adhered to the transporting belts 6 and 7 while being transported (described below).

The ink-jet heads 2 and 3 each have a plurality of nozzles (not shown) for, for example, four colors of yellow (Y), magenta (M), cyan (C), and black (K) disposed at different positions in the print-medium transporting direction. Ink is supplied from ink tanks (not shown) for those colors to the ink-jet heads 2 and 3 via ink-supplying tubes. Moreover, the plurality of nozzles formed in the ink-jet heads 2 and 3 are also arranged in the width direction of the print medium 1 (nozzle-array direction) and minute ink dots are formed on the print medium 1 by discharging the required amounts of ink droplets from the nozzles to desired positions at the same time or at substantially the same time. Letters and images can be printed in a so-called one pass when the above-described operation is performed for each color while the print medium 1 is passed over the ink-jet heads 2 and 3 using the transporting units 4 and 5 only one time. That is, the areas in which the ink-jet heads 2 and 3 are arranged correspond to the printing areas.

Ink can be discharged from the nozzles of the ink-jet heads using, for example, the electrostatic effect, the piezoelectric effect, or film boiling. In the method using the electrostatic effect, driving signals are supplied to electrostatic gaps serving as actuators such that the positions of vibrating plates inside cavities are changed. With this, the pressure inside the cavities is changed, and ink droplets are discharged from nozzles in response to the pressure change. In the method using the piezoelectric effect, driving signals are supplied to piezoelectric elements serving as actuators such that the positions of vibrating plates inside cavities are changed. With this, the pressure inside the cavities is changed, and ink droplets are discharged from nozzles in response to the pressure change. In the method using film boiling, minute heaters disposed inside cavities instantaneously heat ink to a temperature of 300° C. or more such that film boiling occurs and bubbles are generated. With this, the pressure inside the cavities is changed, and ink droplets are discharged from nozzles in response to the pressure change. Any of these ink-discharging methods can be applicable to the invention.

As shown in FIG. 1A, the first ink-jet heads 2 are disposed between two adjacent first transporting belts 6 in the first transporting unit 4 and outside the outermost first transporting belts 6, and the second ink-jet heads 3 are disposed between two adjacent second transporting belts 7 in the second transporting unit 5. In order to print a whole page, the ink-jet heads 2 and 3 are disposed at different positions in the print-medium transporting direction so that the printing areas compensate for each other.

A pair of gate rollers 14 is disposed upstream of the first driven roller 9 so as to adjust timing of feeding the print medium 1 supplied from a paper-feeding section 15 and so as to correct the inclination of the print medium 1 with respect to the print-medium transporting direction. Moreover, feed rollers (not shown) are disposed upstream of the gate rollers 14 so as to supply the print medium 1 from the paper-feeding section.

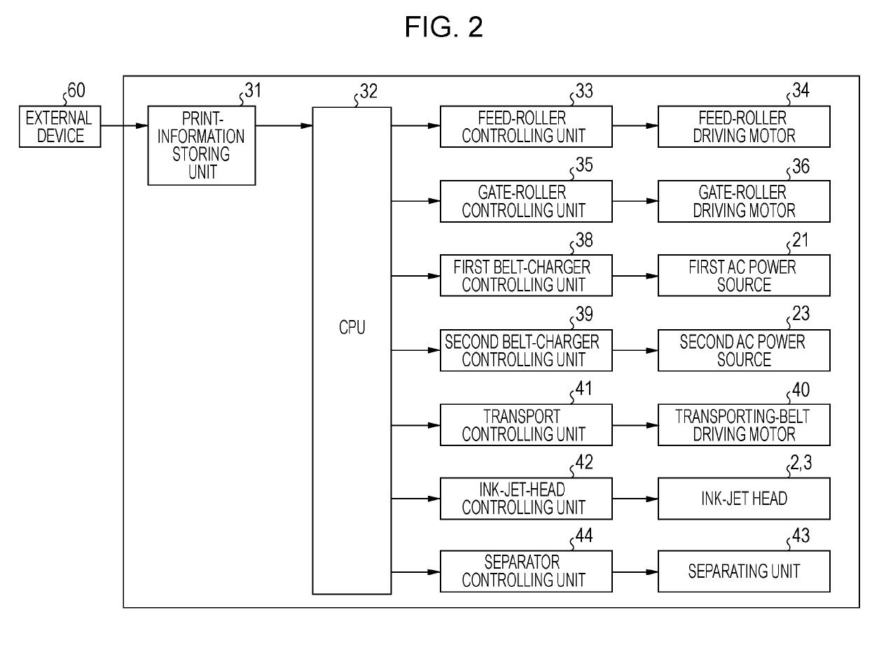

A first belt-charging unit and a second belt-charging unit are disposed under the first driven roller 9 and the driving roller 8, respectively. The first belt-charging unit includes a first charging roller 20 that is in contact with the first transporting belts 6, the first transporting belts 6 being interposed between the first charging roller 20 and the first driven roller 9, and a first alternating-current (AC) power source 21 (see FIG. 2) that charges the first charging roller 20. The second belt-charging unit includes a second charging roller 22 that is in contact with the second transporting belts 7, the second transporting belts 7 being interposed between the second charging roller 22 and driving roller 8, and a second AC power source 23 (see FIG. 2) that charges the second charging roller 22. The charging rollers 20 and 22 supply electrical charges to the transporting belts 6 and 7 so as to charge the belts. The AC power sources supply alternating voltages of frequencies of about 10 to 50 Hz. Since typical belts are composed of middle-resistance or high-resistance materials or insulating materials and the print medium 1 is composed of a high-resistance material or an insulating material, electrical charges supplied to the surfaces of the belts by the belt-charging units cause dielectric polarization of the print medium 1. The electrical charges generated by the dielectric polarization and those on the surfaces of the belts generate electrostatic force therebetween. With this, the print medium 1 is adhered to the belts. The surfaces of the charged belts have the same potential. The belts can be charged by, for example, so-called corotrons that supply electrical charges.

The ink-jet printer includes a controller (not shown) for controlling itself. The controller prints on the print medium 1 by controlling the printing section and the paper-feeding and paper-discharging sections as shown in, for example, FIG. 2 on the basis of print information input from an external device 60 such as personal computers and digital cameras. The ink-jet printer further includes a print-information storing unit 31 that stores the print information input from the external device 60, a central processing unit (CPU) 32 that performs processes such as printing, a feed-roller controlling unit 33 that controls a feed-roller driving motor 34 for driving the feed rollers on the basis of commands from the CPU 32, a gate-roller controlling unit 35 that controls a gate-roller driving motor 36 for driving the gate rollers 14 on the basis of the commands from the CPU 32, a first belt-charger controlling unit 38 that controls the first AC power source 21 on the basis of the commands from the CPU 32, a second belt-charger controlling unit 39 that controls the second AC power source 23 on the basis of the commands from the CPU 32, a transport controlling unit 41 that controls the transporting-belt driving motor 40 for driving the driving roller 8 on the basis of the commands from the CPU 32, an ink-jet-head controlling unit 42 that controls the ink-jet heads 2 and 3 on the basis of the commands from CPU 32, and a separator controlling unit 44 that controls a separating unit 43 disposed upstream of the paper-discharging section on the basis of the commands from the CPU 32.

In this ink-jet printer, the surfaces of the first transporting belts 6 are charged by the first charging roller 20 in the first belt-charging unit first. In this state, the print medium 1 is fed by the feed rollers, and the inclination of the print medium 1 is adjusted by the gate rollers 14. Subsequently, the print medium 1 is fed to a position above the first transporting belts 6, and is pressed to the first transporting belts 6 by a pushing roller (not shown). With this, the print medium 1 is adhered to the surfaces of the first transporting belts 6 by the effect of dielectric polarization described above. In this state, the driving roller 8 is rotated by the transporting-belt driving motor 40. The driving force is transmitted to the first driven roller 9 via the first transporting belts 6.

The print medium 1 is moved downstream in the print-medium transporting direction to a position below the first ink-jet heads 2 while being adhered to the first transporting belts 6. Subsequently, ink droplets are discharged from the nozzles formed in the first ink-jet heads 2. After printing using the first ink-jet heads 2 is finished, the print medium 1 is moved downward in the print-medium transporting direction, and transferred to the second transporting belts 7 in the second transporting unit 5. Since the surfaces of the second transporting belts 7 are charged by the second charging roller 22 in the second belt-charging unit as described above, the print medium 1 is adhered to the surfaces of the second transporting belts 7 by the effect of the dielectric polarization described above.

In this state, the second transporting belts 7 are moved downstream in the print-medium transporting direction to a position below the second ink-jet heads 3. Subsequently, ink droplets are discharged from the nozzles formed in the second ink-jet heads 3. After printing using the second ink-jet heads 3 is finished, the print medium 1 is further moved downward in the print-medium transporting direction, and discharged to the paper-discharging section while the print medium 1 is separated from the surfaces of the second transporting belts 7 by the separating unit 43 (see FIG. 2).

When the ink-jet heads 2 and 3 need to be cleaned, first and second cleaning units disposed, for example, below the transporting belts 6 and 7, respectively, are moved upward, and cap members of the first and the second cleaning units are brought into close contact with the nozzle surfaces of the ink-jet heads 2 and 3. In this arrangement, the cap members are evacuated to a negative pressure such that ink droplets and bubbles are sucked out of the nozzles of the ink-jet heads 2 and 3. After cleaning, the first and second cleaning units are moved downward.

In this embodiment, two types of print-medium guides are provided for the paper-feeding section 15. A pair of first print-medium guides 11 is disposed upstream in the print-medium transporting direction, and guides both sides of the print medium 1 in the width direction thereof when the print medium 1 is disposed such that the longitudinal direction thereof is parallel to the print-medium transporting direction. A pair of second print-medium guides 12 is disposed downstream in the print-medium transporting direction, and guides both sides of the print medium 1 in the width direction thereof when the print medium 1 is disposed such that the lateral direction thereof is parallel to the print-medium transporting direction. The pairs of print-medium guides 11 and 12 can be moved by, for example, users so as to be suited for both sides of the print medium 1 in the width direction thereof. When one of the four print-medium guides is moved so as to be suited for one of the two sides of the print medium 1 in the width direction thereof, the other print-medium guide in the same pair is moved so as to be suited for the other side of the print medium 1 in the width direction by, for example, a rack-and-pinion mechanism (not shown). Moreover, when one of the pairs of the print-medium guides 11 and 12 is moved so as to be suited for both sides of the print medium 1 in the width direction thereof, the other pair of print-medium guides 11 or 12 is moved so as to be separated from both sides of the print medium 1 in the width direction by, for example, a link mechanism (not shown).

In this embodiment, the four first transporting belts 6 in the first transporting unit 4 and the five second transporting belts 7 in the second transporting unit 5 are alternately disposed in a staggered manner as shown in FIG. 1A. Moreover, the first ink-jet heads 2 are disposed between two adjacent first transporting belts 6 in the first transporting unit 4 and outside the outermost first transporting belts 6, and the second ink-jet heads 3 are disposed between two adjacent second transporting belts 7 in the second transporting unit 5. Since the transporting belts 6 and 7 have the same width and the surfaces of the charged belts have the same potential, all the belts have the same attracting force, i.e., transporting force of the print medium 1. Therefore, the centerline of the printing area of the first ink-jet heads 2 in the width direction of the print medium corresponds to that of the printing area of the second ink-jet heads 3 in the width direction of the print medium, and these centerlines correspond to the centerline of the first transporting unit 4 including the four first transporting belts 6 in the width direction of the print medium and that of the second transporting unit 5 including the five second transporting belts 7 in the width direction of the print medium. Furthermore, the centerlines of the printing areas of the ink-jet heads 2 and 3 in the width direction of the print medium correspond to the centerline of the print medium 1 in the width direction thereof. Thus, all these centerlines correspond to each other in the width direction of the print medium. With this, the print-medium guides 11 and 12 can guide the print medium 1 to the first transporting unit 4 such that the centerline of the print medium 1 in the width direction thereof corresponds to the centerlines of the printing areas of the ink-jet heads 2 and 3 in the width direction of the print medium.

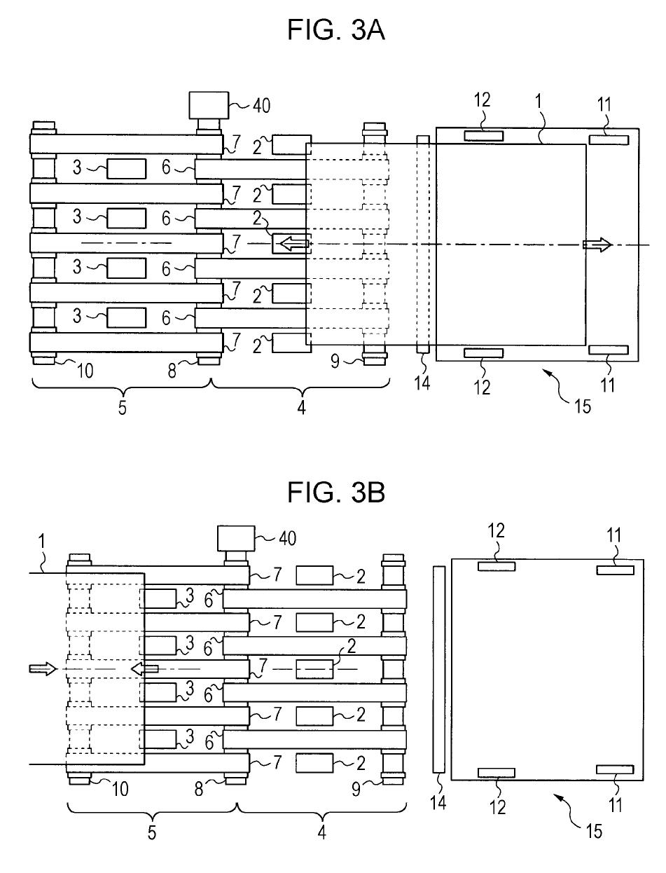

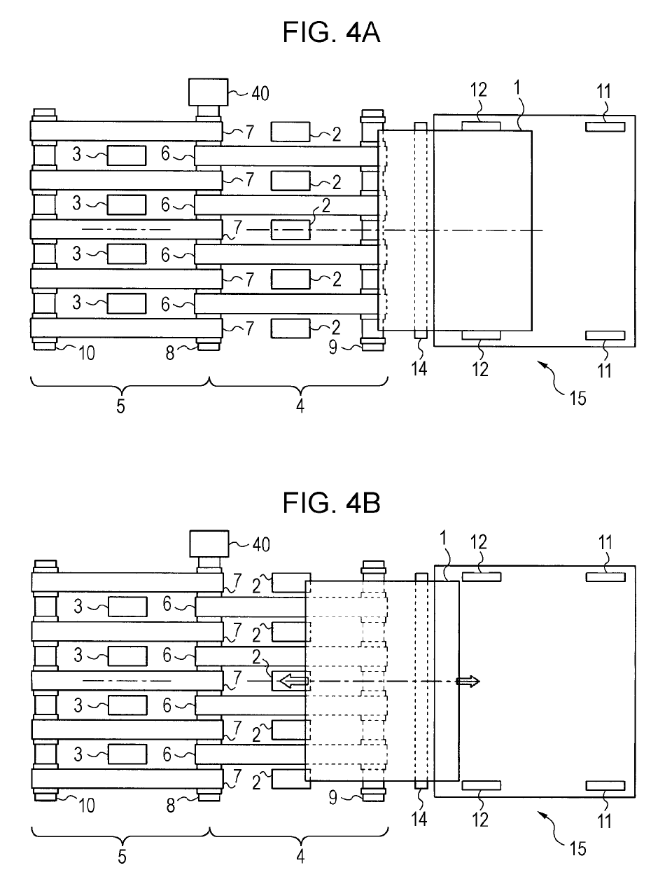

FIG. 3A illustrates a state where the print medium 1 of, for example, an A3 size is disposed on the paper-feeding section 15 such that the longitudinal direction thereof is parallel to the print-medium transporting direction, and is guided by the first print-medium guides 11 so as to be placed on the first transporting unit 4. FIG. 3B illustrates a state where the print medium 1 is discharged from the second transporting unit 5 to the paper-discharging section. Similarly, FIG. 4A illustrates a state where the print medium 1 of, for example, an A4 size is disposed on the paper-feeding section 15 such that the lateral direction thereof is parallel to the print-medium transporting direction, and is guided by the second print-medium guides 12 so as to be placed on the first transporting unit 4. FIG. 4B illustrates a state where the print medium 1 is discharged from the second transporting unit 5 to the paper-discharging section. The print-medium guides 11 and 12 are separated from the print medium 1 before ink droplets are discharged from the first ink-jet heads 2.

As shown in FIGS. 3A and 4A, the centerline of the first transporting unit 4 in the width direction of the print medium corresponds to the centerlines of the printing areas of the ink-jet heads 2 and 3 in the width direction of the print medium, i.e., the centerline of the print medium 1 in the width direction thereof in this embodiment. Therefore, the centerline of the transporting force of the first transporting unit 4 in the width direction of the print medium corresponds to that of the transporting load, caused by frictional resistance and the like of the print-medium guides 11 and 12 and the paper-feeding section 15, of the print medium 1 in the width direction of the print medium. As a result, no rotating force acts on the print medium 1 when the print medium 1 is placed on the first transporting unit 4, and the print medium 1 can be placed on the first transporting unit 4 at an appropriate position and at an appropriate angle.

Moreover, as shown in FIGS. 3B and 4B, the centerline of the second transporting unit 5 in the width direction of the print medium corresponds to the centerlines of the printing areas of the ink-jet heads 2 and 3 in the width direction of the print medium, i.e., the centerline of the print medium 1 in the width direction thereof. Therefore, the centerline of the transporting force of the second transporting unit 5 in the width direction of the print medium corresponds to that of the transporting load, caused by frictional resistance and the like of the paper-discharging section, of the print medium 1 in the width direction of the print medium. As a result, no rotating force acts on the print medium 1 when the print medium 1 is discharged from the second transporting unit 5, and the print medium 1 can be discharged from the second transporting unit 5 at an appropriate angle.

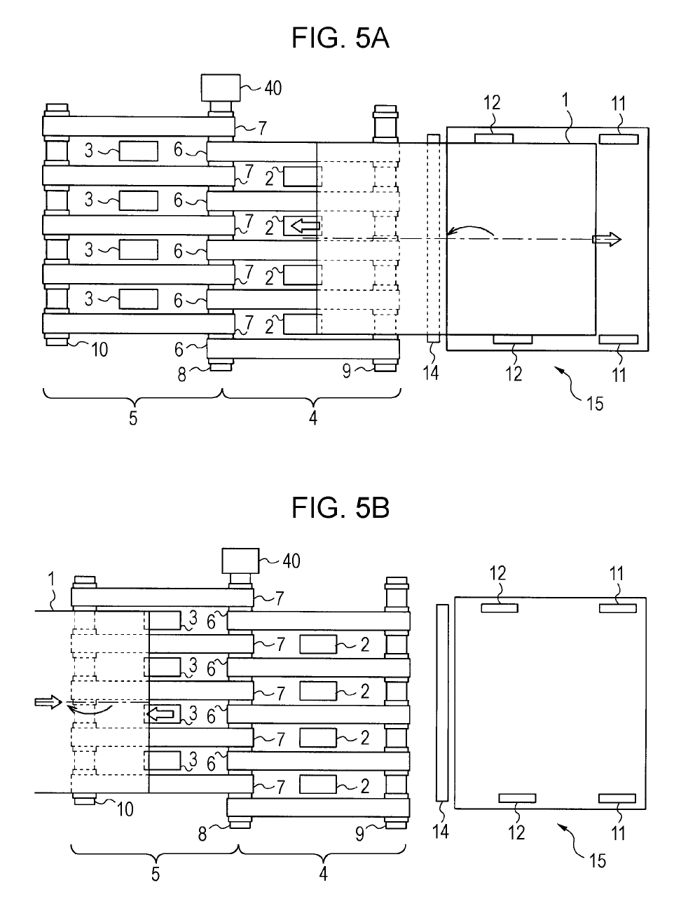

FIGS. 5A and 5B illustrate a comparative example of the above-described embodiment including a first transporting unit 4 having five first transporting belts 6, a second transporting unit 5 having five second transporting belts 7, and ink-jet heads 2 and 3 disposed only between the transporting belts 6 and 7. For ease of understanding, the same reference numbers used in the above-described embodiment are used. The ink-jet heads 2 and 3 are often arranged in this manner when disposed at different positions in the print-medium transporting direction since the number of ink-jet heads can be reduced with this arrangement. The centerline of the printing area of the first ink-jet heads 2 in the width direction of the print medium corresponds to that of the first transporting unit 4 in the width direction of the print medium, and the centerline of the printing area of the second ink-jet heads 3 in the width direction of the print medium corresponds to that of the second transporting unit 5 in the width direction of the print medium with this arrangement. However, the centerline of the printing area of the first ink-jet heads 2 in the width direction of the print medium and that of the printing area of the second ink-jet heads 3 in the width direction of the print medium do not correspond to each other.

The print medium 1 is placed on the first transporting unit 4 while being guided by print-medium guides 11 or 12 such that the centerline of the print medium 1 in the width direction thereof is located at an intermediate position between the centerline of the printing area of the first ink-jet heads 2 in the width direction of the print medium and that of the printing area of the second ink-jet heads 3 in the width direction of the print medium as shown in FIG. 5A. Subsequently, the print medium 1 is discharged from the second transporting unit 5 as shown in FIG. 5B.

As shown in FIG. 5A, the centerline of the first transporting unit 4 in the width direction of the print medium does not correspond to that of the print medium 1 in the width direction thereof. Therefore, the centerline of the transporting force of the first transporting unit 4 in the width direction of the print medium does not correspond to that of the transporting load, caused by frictional resistance and the like of the print-medium guides 11 and 12 and a paper-feeding section 15, of the print medium 1 in the width direction of the print medium. As a result, a rotating force shown by an arrow in FIG. 5A acts on the print medium 1 when the print medium 1 is placed on the first transporting unit 4, and the print medium 1 cannot be placed on the first transporting unit 4 at an appropriate position and at an appropriate angle.

Moreover, as shown in FIG. 5B, the centerline of the second transporting unit 5 in the width direction of the print medium does not correspond to that of the print medium 1 in the width direction thereof. Therefore, the centerline of the transporting force of the second transporting unit 5 in the width direction of the print medium does not correspond to that of the transporting load, caused by frictional resistance and the like of a paper-discharging section, of the print medium 1 in the width direction of the print medium. As a result, a rotating force shown by an arrow in FIG. 5B acts on the print medium 1 when the print medium 1 is discharged from the second transporting unit 5, and the print medium 1 cannot be discharged from the second transporting unit 5 at an appropriate angle.

In accordance with the ink-jet printer according to above-described embodiment, the plurality of ink-jet heads 2 and 3 are disposed at different positions in the print-medium transporting direction, and the centerlines of the printing areas of the ink-jet heads 2 and 3 in the width direction of the print medium correspond to each other. At the same time, the centerlines of the printing areas of the ink-jet heads 2 and 3 in the width direction of the print medium correspond to those of the transporting forces of the plurality of transporting belts 6 and 7 in the width direction of the print medium, and the print-medium guides 11 and 12 guide the print medium 1 to the transporting belts 6 and 7 such that the centerlines of the transporting forces of the transporting belts 6 and 7 in the width direction of the print medium correspond to the centerline of the print medium 1 in the width direction thereof. Thus, the centerlines of the transporting forces of the transporting units 4 and 5 including the transporting belts 6 and 7 and those of the transporting loads generated at the print-medium guides 11 and 12 and the paper-feeding section 15 correspond to each other in the width direction of the print medium, and the print medium 1 can be placed on the transporting units 4 and 5 at an appropriate position and at an appropriate angle.

Moreover, the print-medium guides 11 and 12 are separated from the print medium 1 before ink droplets are discharged from the ink-jet heads 2 and 3. With this, changes in position of the print medium 1 caused by the transporting load generated at the print-medium guides 11 and 12 while ink droplets are discharged from the ink-jet heads 2 and 3 (during printing) can be reliably prevented. Moreover, the transporting units 4 and 5 including the plurality of transporting belts 6 and 7, respectively, are disposed at different positions in the print-medium transporting direction; and the centerlines of the transporting forces of the transporting units 4 and 5 correspond to each other in the width direction of the print medium. Therefore, the centerlines of the transporting forces of the transporting units 4 and 5 reliably correspond to those of the transporting loads generated at the print-medium guides 11 and 12 and the paper-feeding section 15 in the width direction of the print medium when the print medium 1 is placed on the transporting belts of either of the transporting units 4 and 5, and the print medium 1 can be placed on the transporting units 4 and 5 at an appropriate position and at an appropriate angle.

In the above-described embodiment, the centerlines of the transporting forces of the transporting belts 6 and 7 in the width direction of the print medium are defined as those of the transporting belts 6 and 7 in the width direction of the print medium when the transporting belts 6 and 7 have the same width. Therefore, the centerlines of the transporting forces of the transporting belts 6 and 7 in the width direction of the print medium can be easily found. This facilitates the implementation of the invention.

In the above-described embodiment, the ink-jet heads are disposed at two different positions in the print-medium transporting direction. However, the positions of the ink-jet heads are not limited to these. That is, the ink-jet heads can be disposed at three or more different positions in the print-medium transporting direction as long as the centerlines of the printing areas of the ink-jet heads in the width direction of the print medium, the centerlines of the transporting units including the plurality of transporting belts in the width direction of the print medium, and the centerline of the print medium in the width direction thereof correspond to each other.

In the above-described embodiment, only an ink-jet printer of the so-called line-head type has been described as an example. However, the ink-jet printer according to the embodiment of the invention can be of any other types including the multi-pass type.

What is claimed is:

1. An ink-jet printer comprising:
a transporting unit that includes a plurality of transporting belts for transporting a print medium disposed at predetermined intervals in the width direction of the print medium;
a first ink-jet head that discharges ink droplets to the print medium disposed on the transporting belts, wherein the centerline of the printing area of the first ink-jet head in the width direction of the print medium corresponds to the centerline of the transporting force of the transporting belts in the width direction of the print medium;
a second ink-jet head disposed in series of the first ink-jet head in a direction in which the print medium is transported, wherein the centerline of the printing area of the second ink-jet head in the width direction of the print medium corresponds to the centerline of the printing area of the first ink-jet head in the width direction of the print medium; and
a print-medium guide that adjusts the position of the centerline of the print medium in the width direction of the print medium such that the centerline of the print medium corresponds to the centerline of the transporting force of the transporting belts in the width direction of the print medium when the print medium is placed on the transporting belts.

2. The ink-jet printer according to claim 1, wherein the print-medium guide is separated from the print medium before ink droplets are discharged from the ink-jet heads.

3. The ink-jet printer according to claim 1, wherein
the ink-jet printer further includes one or more transporting units, including a plurality of transporting belts, disposed at different positions in the direction in which the print medium is transported, and
the centerlines of the transporting forces of the transporting units correspond to each other in the width direction of the print medium.

4. The ink-jet printer according to claim 1, wherein
the transporting belts have the same width, and
the centerline of the transporting force of the transporting belts corresponds to the centerline of the transporting belts in the width direction of the print medium.
